(19) United States
(12) Patent Application Publication
(10) Pub. No.: US 2004/0054545 A1
(43) Pub. Date: Mar. 18, 2004

(54) System and method for managing innovation capabilities of an organization

(75) Inventor: Erik A. Knight, The Colony, TX (US)

Correspondence Address: BAKER BOTTS L.L.P., 2001 ROSS AVENUE, SUITE 600, DALLAS, TX, 75201-2980, US

(73) Assignee: Electronic Data Systems Corporation

(21) Appl. No.: 10/243,885

(22) Filed: Sep. 13, 2002

(51) Int. Cl. G06F 17/60

(52) U.S. Cl. 705/1

(57) ABSTRACT

A method includes storing one or more quantitative values associated with one or more innovation capabilities of an organization. Each quantitative value is also associated with one of a plurality of innovation levels. The method also includes determining an expected innovation level for the organization. The expected innovation level comprises one of the plurality of innovation levels. The method further includes identifying an innovation capability having a quantitative value associated with an innovation level that falls below the expected innovation level value. In addition, the method includes identifying one or more solutions associated with the identified innovation capability. The one or more solutions are operable to increase the innovation level associated with the quantitative value.

### TECHNICAL FIELD

This disclosure relates generally to enterprise systems, and more specifically to a system and method for managing innovation capabilities of an organization.

### BACKGROUND

Innovation is often a driving force behind the long-term success of certain businesses and other organizations. Innovation allows an organization to introduce or use something new, such as new products, services, or manufacturing processes. The new products, services, or processes could be used internally within the organization or made available externally, such as to the organization's customers or partners. The ability to innovate also typically helps to differentiate one organization from its competitors. As a particular example, a software company typically requires large amounts of innovation to remain competitive in the entertainment software industry. The long-term success of the software company often depends on the company's ability to create new games for its customers. It is typically difficult for an organization to measure and manage its innovation capabilities. Also, an organization typically has problems identifying the amount of innovation it needs in order to remain competitive. In addition, an organization typically has difficulty determining if and when it possesses the desired level of innovation capabilities.

### SUMMARY

One aspect of this disclosure is a method that includes storing one or more quantitative values associated with one or more innovation capabilities of an organization. Each quantitative value is also associated with one of a plurality of innovation levels. The method also includes determining an expected innovation level for the organization. The expected innovation level comprises one of the plurality of innovation levels. The method further includes identifying an innovation capability having a quantitative value associated with an innovation level that falls below the expected innovation level value. In addition, the method includes identifying one or more solutions associated with the identified innovation capability. The one or more solutions are operable to increase the innovation level associated with the quantitative value.

One or more advantages may be provided according to various embodiments of this disclosure. Particular embodiments of this disclosure may exhibit none, some, or all of the following advantages depending on the implementation. For example, in one embodiment, the innovation capabilities of an organization can be measured in a quantifiable manner. This may provide a way for an organization to actually identify its current innovation capabilities. The actual innovation capabilities of the organization can also be compared to a desired or needed level of innovation. This may help to determine where an organization lacks innovation capabilities and determine possible solutions to fix any problems. In addition, the real-time innovation capabilities of an organization can be displayed to a user. This may allow the innovation capabilities of the organization, along with any improvements, to be monitored more easily by the user.

Other advantages may be readily apparent to one skilled in the art from the following figures, descriptions, and claims.

### BRIEF DESCRIPTION OF THE DRAWINGS

For a more complete understanding of this disclosure and the advantages thereof, reference is now made to the following descriptions, taken in connection with the accompanying drawings, in which:

FIG. 1 illustrates an example system for managing innovation capabilities of an organization;

FIG. 2 illustrates an example structure of an organization;

FIG. 3 illustrates example innovation quotients for various types of organizations;

FIG. 4 illustrates example factors associated with possible innovation maturity levels of an organization;

FIG. 5 illustrates an example innovation matrix for quantitatively modeling innovation capabilities of an organization;

FIG. 6 illustrates an example display identifying current innovation capabilities of an organization;

FIG. 7 illustrates an example method for managing innovation capabilities of an organization;

FIG. 8 illustrates an example method for identifying an innovation maturity level of an organization; and

FIG. 9 illustrates an example method for displaying current innovation capabilities of an organization.

### DETAILED DESCRIPTION OF EXAMPLE EMBODIMENTS

FIG. 1 illustrates an example system 100 for managing innovation capabilities of an organization. In the illustrated embodiment, system 100 includes a server 102, a database 104, a network 106, and a client 108. Other embodiments of system 100 can be used without departing from the scope of this disclosure.

In one aspect of operation, system 100 may store and process information related to the innovation capabilities of an organization. Innovation refers to the ability of an organization to create, introduce, employ, or otherwise use something new. The results of the innovation may include, for example, new products or services offered to customers of the organization, new packaging for products offered to customers, and new manufacturing processes used to produce a product. Also, the results of the innovation may represent completely new concepts or ideas, new uses for old ideas, or any other suitable type of innovation.

The processes, tools, and other mechanisms used by an organization to create, implement, or otherwise support innovation may be referred to as the innovation capabilities of the organization. An organization can have none, several, or many types of innovation capabilities. An example innovation capability could be a research and development program for creating and developing innovative ideas. Another example innovation capability could be the presence of an awards system that rewards employees when patent applications are filed on their behalf. Yet another example innovation capability could be the existence of a knowledge base or other repository for knowledge that can be accessed and used by members of the organization. The innovation capabilities of an organization can be broken down into any suitable groups. For example, the innovation capabilities may include business processes used by the organization, tools available for use in the organization, financial arrangements, employee programs, and management strategies.

System 100 may support innovation in an organization by storing quantitative information associated with the innovation capabilities of an organization. System 100 may also compare the existing innovation capabilities to a desired or needed level of innovation. In addition, system 100 may measure and display the real-time status of the innovation capabilities to a user, and this display could be customized for a particular user. This may allow system 100 to provide a way for an organization to model its current innovation capabilities, identify problems with its innovation capabilities, and monitor how the innovation capabilities vary over time.

In the illustrated embodiment, server 102 is coupled to database 104 and network 106. In this specification, the term “couple” refers to any direct or indirect communication between two or more elements, whether or not those elements are in physical contact with one another. Server 102 performs one or more functions to measure, model, and/or monitor the innovation capabilities of an organization or a portion of an organization. Server 102 may include any hardware, software, firmware, or combination thereof operable to perform one or more functions associated with the innovation capabilities of an organization. In this specification, system 100 may be described as performing functions related to the innovation capabilities of an entire organization. System 100 could also perform functions related to the innovation capabilities of portions of an organization, such as for a division of an organization. In addition, while server 102 may be described as performing particular functions, these functions could also be performed manually by a user or other personnel.

In the illustrated example, server 102 includes a processor 110 and a memory 112. Processor 110 executes instructions and manipulates data to perform the operations of server 102. Although FIG. 1 illustrates a single processor 110 in server 102, multiple processors 110 may be used according to particular needs. Memory 112 stores and facilitates retrieval of information used by processor 110 to perform the functions of server 102. Memory 112 may, for example, store instructions to be performed by processor 110 and data used by processor 110. Memory 112 may include any hardware, software, firmware, or combination thereof operable to store and facilitate retrieval of information.

Database 104 is coupled to server 102. Database 104 stores and facilitates retrieval of information used by server 102. For example, database 104 may store information quantitatively identifying the innovation capabilities of an organization. This information could be used by server 102 to perform operations in system 100, such as to identify the real-time innovation capabilities of the organization. Database 104 may include any hardware, software, firmware, or combination thereof operable to store and facilitate retrieval of information. Also, database 104 may use any of a variety of data structures, arrangements, and compilations to store and facilitate retrieval of information.

Network 106 is coupled to server 102 and client 108. Network 106 facilitates communication between components of system 100. For example, network 106 may communicate Internet Protocol (IP) packets, frame relay frames, Asynchronous Transfer Mode (ATM) cells, or other suitable information between network addresses. Network 106 may include one or more local area networks (LANs), metropolitan area networks (MANs), wide area networks (WANs), all or a portion of a global network such as the Internet, or any other communication system or systems at one or more locations.

Client 108 is coupled to network 106. Client 108 may perform any of a variety of functions in system 100. For example, client 108 could allow a user to submit information identifying the innovation capabilities of an organization to server 102. Client 108 could also allow the user to submit a request to view the current real-time innovation capabilities of the organization. Client 108 could then display the requested information to the user. Client 108 may include any hardware, software, firmware, or combination thereof operable to communicate with server 102. As a particular example, client 108 may include a web browser 114, which may display information to a user within web pages received from server 102.

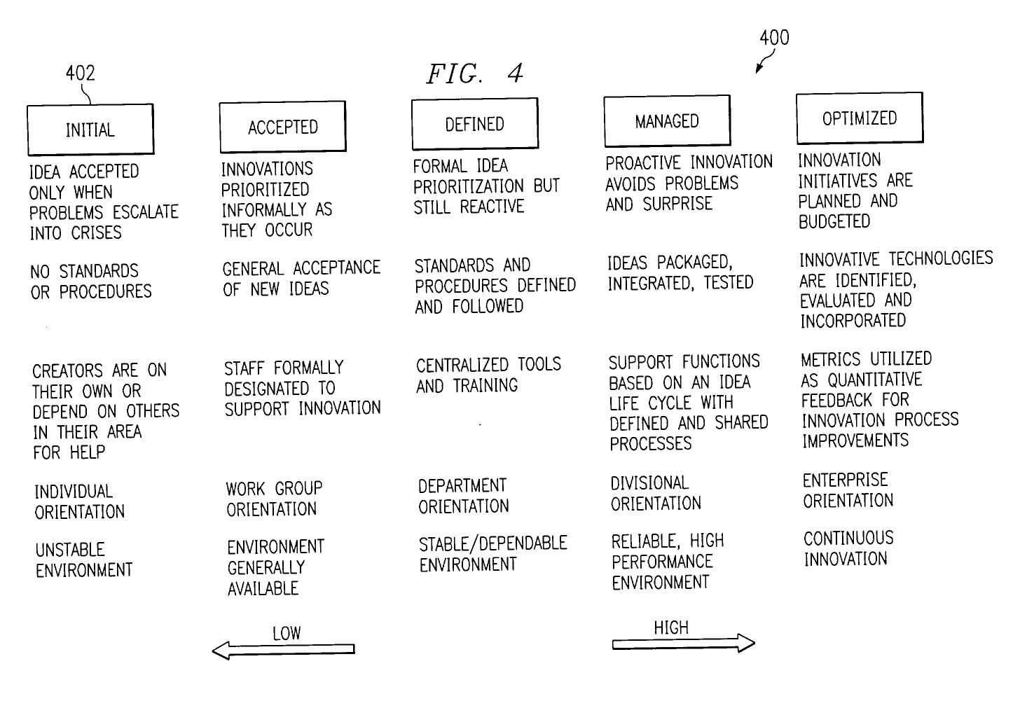

In one aspect of operation, database 104 may store and server 102 may process information related to the innovation capabilities of one or more organizations. For example, in the illustrated embodiment, database 104 includes an innovation matrix 116. Innovation matrix 116 stores quantitative information related to the innovation capabilities of an organization. One example of an innovation matrix is shown in FIG. 5, which is described below. Innovation matrix 116 may store any suitable information identifying the innovation capabilities of an organization. For example, innovation matrix 116 may identify various characteristics of an organization that could be used to support innovation. Possible characteristics may include organizational processes for creating/developing new ideas and financial arrangements for funding these processes. For each characteristic, innovation matrix 116 may include a value identifying how well or how poorly that characteristic supports innovation in the organization. In this specification, the term “each” refers to each of at least a subset of the identified items.

As a particular example, organizations with lower innovation capabilities may have a low value for a particular characteristic. This might be the case, for example, when the organization is a water utility company. Water utility companies may have little or no need for innovative packaging or products. In contrast, organizations with higher innovation capabilities may have a higher value for that particular characteristic. This may be the case, for example, when the organization is a fashion company. Fashion companies typically require large amounts of innovation to remain competitive with one another.

The information contained in innovation matrix 116 could be supplied to, generated by, or otherwise made available to system 100. For example, in one embodiment, the values are made available to server 102 by a user. In this embodiment, during an innovation assessment, the user may analyze the innovation capabilities of an organization with respect to each characteristic of the organization. Based on that assessment, the user may then supply quantitative values to server 102 for storage in innovation matrix 116. In another embodiment, the values in innovation matrix 116 may be generated by server 102. For example, server 102 may make a checklist of various innovation capabilities available to a user, such as through the use of one or more web pages 115. The user can view the web pages 115 and select which innovation capabilities exist in an organization, and server 102 can generate values for innovation matrix 116 based on the user's responses. As a particular example, server 102 could use a weight assigned to each possible innovation capability to give more importance to certain capabilities.

Database 104 may also include one or more innovation quotients 118. An innovation quotient 118 identifies the level of innovation that an organization should possess. For example, in one embodiment, the innovation quotient 118 may vary depending on the industry in which the organization operates. As a particular example, water utility companies typically need little innovation to remain competitive, while fashion companies typically need large amounts of innovation to remain competitive. In this embodiment, the innovation quotients 118 could identify various industries and an associated level of innovation for each industry. The desired level of innovation for a particular organization could then be determined using the industry affiliation of the organization, which may be received from a user or identified in any other suitable manner. In another embodiment, the innovation quotient 118 for a particular organization could be directly supplied to database 104 by a user or identified in any other suitable manner.

Information in database 104 may be used by server 102 to model, measure, and/or manage the innovation capabilities of one or more organizations. In the illustrated example, server 102 includes a gap analyzer 120. Gap analyzer 120 may analyze innovation matrix 116 and the innovation quotient 118 for a particular organization. Based on the comparison, gap analyzer 120 may identify any characteristics of the organization where the current innovation capabilities fall behind the desired innovation quotient 118. These organizational characteristics represent areas where the organization may need improvement. Gap analyzer 120 could also identify any characteristics of the organization where the current innovation capabilities exceed the desired innovation quotient 118. These organizational characteristics represent areas where the organization may be spending too much time, money, or other resources on its innovation capabilities. In another embodiment, problems with the innovation capabilities of an organization can be identified in other ways, such as by a user or other personnel, and gap analyzer 120 may be optional in server 102.

Once gaps are found between the desired innovation quotient 118 and the current innovation capabilities of the organization, possible solutions to close the gaps can be identified. For example, database 104 could store innovation solutions 122, which identify different products, services, or processes that might be used to improve or supplement the current innovation capabilities of the organization. In a particular embodiment, innovation solutions 122 are divided according to each organizational characteristic modeled by innovation matrix 116. When the innovation capabilities associated with a particular organizational characteristic fall below the desired innovation quotient 118, gap analyzer 120 could access innovation solutions 122 and identify possible solutions associated with that characteristic. Gap analyzer 120 could then make the identified solutions available to a user or other personnel. In another embodiment, solutions used to resolve problems with the innovation capabilities of an organization can be identified in other ways, such as by a user or other personnel. Gap analyzer 120 may include any hardware, software, firmware, or combination thereof operable to identify problems with and/or analyze data associated with an organization's innovation capabilities. Gap analyzer 120 may, for example, represent one or more software routines executed by processor 110.

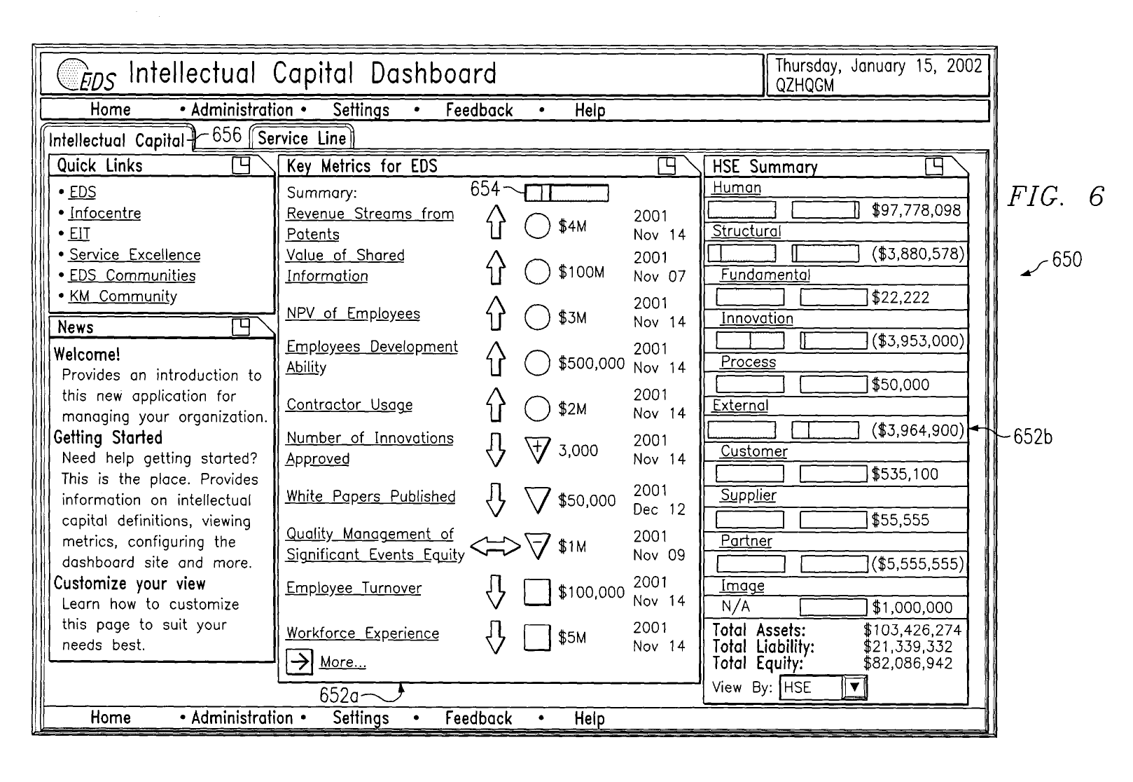

Server 102 also includes a dashboard generator 124. Dashboard generator 124 displays real-time information regarding the innovation capabilities of an organization to a user. For example, dashboard generator 124 may generate a web page showing real-time information about the innovation capabilities of the organization. As particular examples, dashboard generator 124 could generate web pages showing the percentage of money awarded to employees under an invention awards program or the total number of patent applications filed in the current fiscal year. Dashboard generator 124 could use any suitable information to generate the displays for the user. For example, dashboard generator 124 could access data stores 126 maintained by one or more organizations. The data stores 126 could represent databases, repositories, spreadsheets, reporting systems, or other tools supported in system 100. Dashboard generator 124 could access the data stores 126 over one or more networks 106. Dashboard generator 124 could also retrieve organizational information 128 from the data stores 126 and generate a web page using the organizational information 128. The organizational information 128 could represent data associated with the innovation capabilities of the organization, such as the number of patent applications filed in the current fiscal year. In a particular embodiment, dashboard generator 124 could create a customized display for a user by displaying specific types of organizational information 128. One example of a display created by dashboard generator 124 is shown in FIG. 6, which is described below. Dashboard generator 124 may include any hardware, software, firmware, or combination thereof operable to display information associated with the innovation capabilities of an organization. Dashboard generator 124 may include any hardware, software, firmware, or combination thereof operable to display innovation information to one or more users. Dashboard generator 124 may, for example, represent one or more software routines executed by processor 110.

Although FIG. 1 illustrates one example of a system 100 for managing innovation capabilities of an organization, various changes may be made to system 100. For example, the functional division of server 102 is for illustration only. Components of server 102 can be combined or omitted and additional components can be added according to particular needs. Also, various functions attributed to server 102 could be performed by other components of system 100 or manually without the use of server 102. As a particular example, in another embodiment, a user could produce the quantitative values stored in innovation matrix 116, identify gaps in the organization's innovation capabilities, and identify possible solutions. In this embodiment, server 102 could include dashboard generator 124 to allow users to monitor the real-time status of the organization's innovation capabilities. In addition, although FIG. 1 illustrates the use of a client-server operating environment, other operational environments could be used.

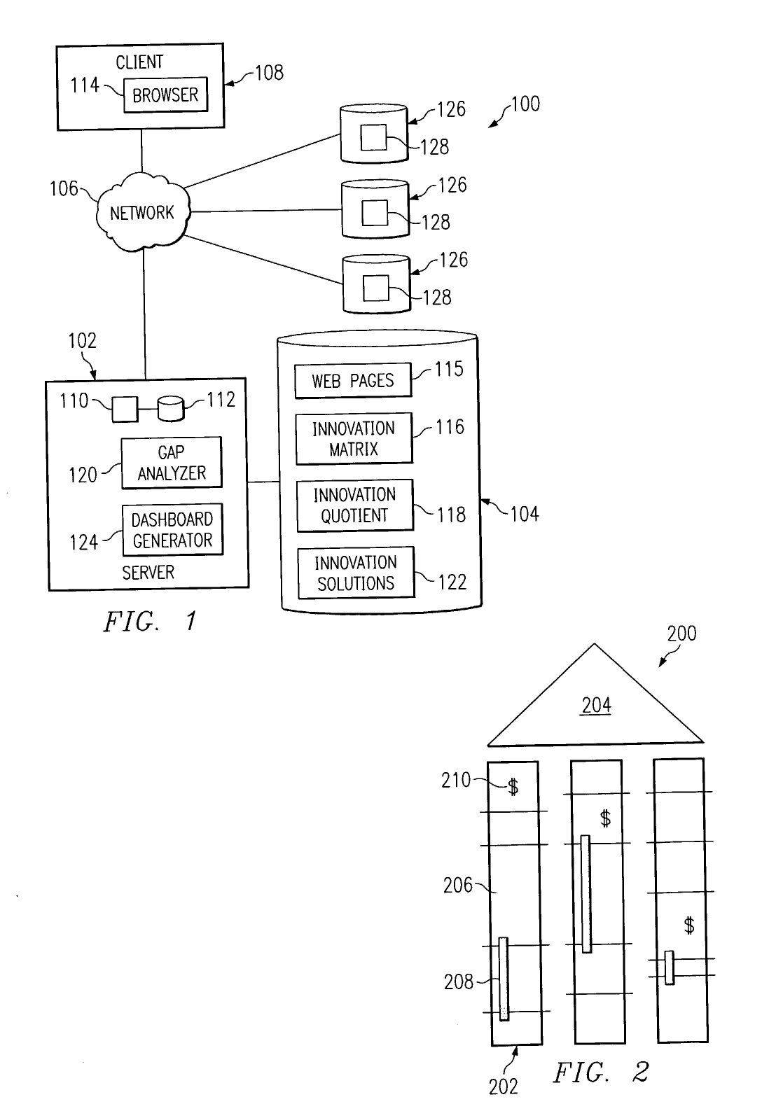

FIG. 2 illustrates an example structure of an organization 200. Organization 200 could, for example, represent an organization using system 100 of FIG. 1. In the illustrated embodiment, organization 200 includes a plurality of divisions 202 and a management structure 204. Other organizations having other structures could also use system 100.

In this example, each division 202 includes a plurality of levels 206. Levels 206 may represent various levels of employees in a division 202. For example, levels 206 may include line workers, line managers, workgroup managers, and department managers. Other or additional types of levels 206 can be used in each division 202, and each division 202 may include any number of levels 206.

The relationship between divisions 202 may vary depending on the organization 200. For example, in some organizations 200, each division 202 may be responsible for producing the same products or completely different products. In other organizations 200, divisions 202 may be responsible for producing different but related products.

Management structure 204 represents one or more layers of management responsible for divisions 202. Management structure 204 may include, for example, the chief executive officer, chief financial officer, chief operating officer, chief information officer, and human resources personnel of organization 200. Management structure 204 could also represent other or additional members of organization 200.

In the illustrated example, each division 202 may include one or more processes 208 that support innovation in organization 200. Processes 208 may, for example, include processes that support the creation of innovative ideas and processes that support the development and implementation of those ideas. As a particular example, a process 208 could represent a process for employees to disclose new ideas and managers to decide whether to file patent applications for those new ideas. Each division 202 may also have access to innovation funding 210. Funding 210 represents money or other resources that can be used to create, develop, and/or implement innovative ideas. As a particular example, funding 210 could represent funds for rewarding employees when the managers decide patent applications should be filed for the employees' ideas.

As shown in FIG. 2, a process 208 or funding 210 may not be supported in all levels 206 of a division 202. This may occur, for example, when a process 208 used by employees in lower levels 206 of a division 202 are ignored by managers in upper levels 206 of the division 202. This may also occur when funding 210 for innovation processes is made available at some, but not all, levels 206 of a division 202.

During an innovation assessment, server 102 or a user or other personnel may analyze the structure of organization 200 and identify gaps in the organization's innovation capabilities. For example, in analyzing the innovation capabilities of organization 200, the user could determine that a division 202 lacks consistent processes 208 and funding 210. The quantitative value or score for this division 202 could therefore be low. If the division 202 has inconsistent processes 208 but consistent funding 210, the score for that division 202 could be higher. If the division 202 has consistent processes 208 and funding 210, the score for that division 202 could be even higher.

After assessing the innovation capabilities of organization 200, the user or server 102 can identify various solutions to correct gaps in these innovation capabilities. The solutions recommended may vary based on the structure of the organization. For example, if divisions 202 are responsible for producing related products, the solutions could include making processes 208 and funding 210 consistent throughout all divisions 202 and in management structure 204. If each division 202 is responsible for producing completely different products, the solutions could include making processes 208 and funding 210 consistent throughout each division 202.

Although FIG. 2 illustrates one example of a structure of an organization 200, various changes may be made to FIG. 2. For example, system 100 can be used to analyze the innovation capabilities of any organization and is not limited to analyzing organizations depicted in FIG. 2.

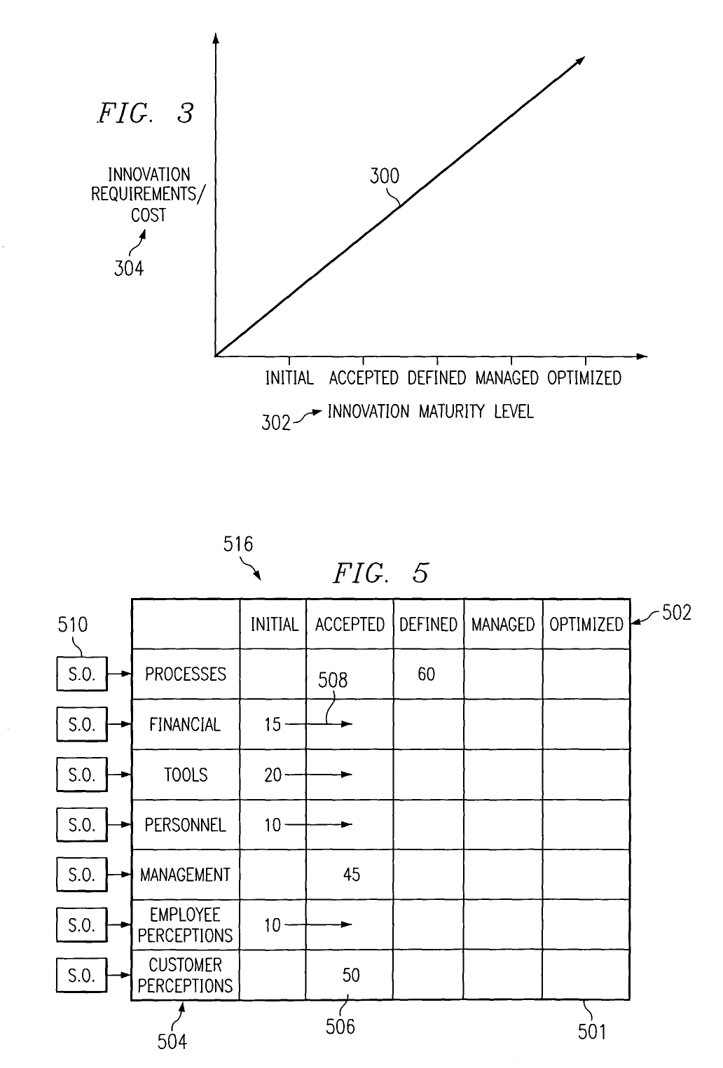

FIG. 3 illustrates example innovation quotients for various types of organizations. In particular, FIG. 3 illustrates innovation quotients 300, which represent the desired amounts of innovation capabilities that different types of organizations should possess. In this example, innovation quotients 300 map different innovation requirements 304 to different innovation maturity levels 302.

In the illustrated example, innovation capabilities within an organization are divided into different innovation maturity levels 302. Each maturity level 302 is associated with a different amount of innovation requirements 304. Lower maturity levels 302 are associated with lower amounts of innovation requirements 304, while higher maturity levels 302 are associated with higher amounts of innovation requirements 304.

In one embodiment, each innovation maturity level 302 is associated with particular industries. For example, the “Initial” innovation maturity level 302 may be associated with utility industries, and the “Accepted” innovation maturity level 302 may be associated with aviation, government, and agricultural industries. Organizations in these industries may need smaller amounts of innovation to remain competitive with one another. In contrast, the “Optimized” innovation maturity level 302 may be associated with entertainment and business software industries, and the “Managed” innovation maturity level 302 may be associated with electronics, fashion, entertainment, and consumer item industries. Organizations in these industries may need larger amounts of innovation to remain competitive. Industries involving automotive, medical, and educational organizations may fall within the “Defined” innovation maturity level 302. These associations between industries and levels 302 are for illustration only. Other or additional relationships between industries and levels 302 could be supported in system 100 according to particular needs.

In this embodiment, the innovation quotient 300 for a particular organization is based, at least partially, on the industry in which the organization operates. Based on the industry affiliation of the organization, the innovation maturity level 302 associated with that industry can be determined. After that, the innovation quotient 300 for the organization can be determined using the identified innovation maturity level 302. The identified innovation quotient 300 for the organization identifies a target level of innovation capabilities for that organization. In other words, the innovation quotient 300 identifies the amount of innovation requirements 304 that the organization should possess to remain competitive with other organizations in the industry in which the organization operates.

The identified innovation quotient 300 for an organization can be used to determine whether the organization's current innovation capabilities need improvement. For example, if a fashion company's capabilities currently fall in the “Initial” level 302, the organization's capabilities need improvement so as to be in the “Managed” level 302. However, if a utility company's capabilities fall in the same level 302, no improvement may be needed. In this way, it is possible to determine whether an organization needs more or improved innovation capabilities without requiring that the organization's competitors be surveyed or analyzed.

In a particular embodiment, two organizations may have different innovation quotients 300 associated with different innovation maturity levels 302. This does not necessarily mean that the innovation capabilities of the organization with the lower innovation quotient 300 need to be improved. This also does not necessarily mean that the organization with the lower innovation quotient 300 is at a competitive disadvantage compared to the organization with the higher innovation quotient 300. For example, an agricultural company may need less innovation than a software company to remain competitive, so the agricultural company does not need a higher innovation quotient 300.

It is possible for an organization to be associated with multiple industries. For example, an organization could produce movies and manufacture consumer electronics. For these organizations, there could be multiple innovation quotients 300 associated with the organization's activities. In that case, different portions of the organization could be treated and analyzed separately, as if each portion was a separate organization. Each portion of the organization may or may not involve common employees, assets, or other resources. For each portion, the portion's innovation capabilities can be measured, gaps can be identified, and solutions can be provided. This may allow, for example, different portions of the organization to be associated with different innovation maturity levels 302.

Although FIG. 3 illustrates one example of innovation quotients 300 for different types of organizations, various changes can be made to FIG. 3. For example, the innovation quotients 300 illustrated in FIG. 3 represent a linear relationship between requirements 304 and innovation levels 302. Other types of relationships could be used. In addition, the labels used to describe innovation maturity levels 302 are for illustration only, and other labels could be used to describe levels 302.

FIG. 4 illustrates example factors 400 associated with possible innovation maturity levels 402 of an organization. Innovation maturity levels 402 may, for example, represent innovation maturity levels 302 of FIG. 3. The factors 400 and maturity levels 402 illustrated in FIG. 4 are for illustration only. Other or additional factors 400 could be associated with other or additional innovation maturity levels 402.

Each innovation maturity level 402 represents different levels or qualities of innovation capabilities in an organization. Lower innovation maturity levels 402 may be associated with organizations having fewer or worse innovation capabilities. Higher innovation maturity levels 402 may be associated with organizations having more or better innovation capabilities.

During an innovation assessment, server 102 or a user or other personnel could use factors 400 to identify the innovation maturity level 402 currently supported by an organization. For example, a user could look at when new ideas are accepted and how those ideas are implemented in the organization. The user could also determine whether processes to support innovation are directed at the individual, workgroup, department, division, or the entire organization. Using these factors, the user can determine what the current innovation maturity level 402 of the organization is.

In a particular embodiment, different characteristics of an organization can be associated with different innovation maturity levels 402. For example, the innovation capabilities of an organization may include business processes used by the organization and tools available for use in the organization. The business processes used by the organization could have characteristics of a high innovation maturity level 402 while the tools have characteristics of a low innovation maturity level 402. This could indicate that the tools used by the organization to support innovation need to be supplemented or improved. This could also indicate that the business processes used by the organization may be wasting resources because less innovation is actually needed.

The factors illustrated in FIG. 4 can also be used to show how the innovation capabilities of an organization can be improved. For example, an organization might reside at the “Initial” level 402 but need to reside at the “Accepted” level 402. In this case, factors 400 illustrate sample differences between the two maturity levels 402. The organization's capabilities can be improved, for example, by refocusing innovation efforts at the workgroup level, formally identifying staff members that support innovation, and informally prioritizing innovative ideas.

Although FIG. 4 illustrates example factors 400 associated with possible innovation maturity levels 402 of an organization, various changes may be made to FIG. 4. For example, the factors 400 shown in FIG. 4 are for illustration only, and other or additional factors 400 could be used. Also, any suitable number of innovation maturity levels 402 can be used.

FIG. 5 illustrates an example innovation matrix 516 for quantitatively modeling innovation capabilities of an organization. In particular, innovation matrix 516 stores quantitative information identifying the strength or weakness of the innovation capabilities of an organization. Innovation matrix 516 may, for example, be useful as innovation matrix 116 in system 100 of FIG. 1.

In the illustrated embodiment, innovation matrix 516 includes a plurality of entries 501. Each entry 501 is associated with an innovation maturity level 502 along one axis and an organizational characteristic 504 along another axis. In this embodiment, innovation maturity levels 502 may be the same as or similar to innovation maturity levels 402 of FIG. 4.

Organizational characteristics 504 identify different aspects or characteristics of an organization that may support innovation in the organization. In the illustrated example, organizational characteristics 504 include processes, financial arrangements, tools, personnel or employees, management, employee perceptions, and customer perceptions. Processes refer to business or other processes that support the creation, development, and/or implementation of innovative ideas in an organization. Regarding the creation of innovative ideas, the processes may include mechanisms for presenting problems to employees, soliciting innovative ideas from the employees, categorizing and prioritizing the ideas, and generating plans, models, costs, analyses, and projections for those ideas. Regarding developing and implementing innovative ideas, the processes may include verifying and testing the ideas, creating market impact and acceptance plans, and identifying emerging market opportunities. Other or additional processes could also be used and supported in an organization.

The tools characteristic 504 may refer to databases or other mechanisms in the organization for tracking ideas through the various processes. Tools could also include software programs used to monitor funding or other resources and track metrics measuring the development or potential of an idea. In this specification, the term “metric” refers to any suitable measurement of a characteristic, such as a characteristic of an organization.

The financial arrangements characteristic 504 may refer to how financial resources are allocated to support innovation. For example, this characteristic 504 may involve whether funding for supporting innovation is separate from funding for ordinary business operations. This may also include whether proper standards are used to allocate funds. For example, funding for ordinary business operations typically use standards that try to minimize risks. Because innovation typically involves taking risks, using the same standards may be inappropriate.

The personnel characteristic 504 may refer to the environment in which employees operate. For example, this may involve the ability of employees to collaborate and identify problems facing the organization and possible solutions. This may also involve the presence of an employee reward program. This could further involve the presence of training programs to ensure that employees know what tools, resources, and programs are available to support innovation. In addition, this can involve innovation review processes that move an idea along the chain of command so that a final decision can be made quickly, allowing processes and products of the organization to be reformed, and ensuring that members of management understand and support innovation as a potential business tool.

The management characteristic 504 may include whether managers in the organization are trained to understand the importance of intellectual property rights and the processes and tools available in the organization. This may also include whether the management in the organization encourages employees to use the available tools and processes.

The employee perception characteristic 504 looks at the perceptions of the employees regarding the various processes and tools available in the organization. For example, the organization may have an automated invention disclosure tool that allows employees to submit ideas for review, but the employees may feel that the tool is too difficult and time-consuming to use. Because this perception may influence the ability of the organization to innovate, this characteristic 504 determines how those perceptions influence the innovation capabilities of the organization.

Finally, the customer perception characteristic 504 looks at the perceptions of the organization's customers regarding the value of the organization's innovation capabilities. For example, the organization may have many different innovation capabilities, but the organization's customers may see little value coming from the innovation. This characteristic 504 involves determining whether the organization's activities are generating an effect with respect to the customers.

The above descriptions regarding the various organizational characteristics 504 are for illustration only. Each organizational characteristic 504 could involve other or additional aspects of an organization without departing from the scope of this disclosure. Also, other or additional characteristics 504 could be modeled using transition matrix 516.

For each organizational characteristic 504, innovation matrix 516 contains a score or value 506. The innovation maturity level 502 associated with value 506 identifies the current innovation maturity level for that particular organizational characteristic 504. For example, in FIG. 5, the value 506 for the “Process” characteristic 504 appears in the “Defined” maturity level 502. This might indicate that the organization has formal but reactive idea prioritization processes.

The value 506 for a particular organizational characteristic 504 represents the strength or weakness of that characteristic 504. Returning to the above example, a value 506 of “60” may indicate that the organization possesses strong prioritization processes. A lower value 506 might be assigned if the organization's prioritization processes suffered from some defect identified during the innovation assessment.

Once values 506 are stored in innovation matrix 516, gaps 508 in the organization's innovation capabilities can be identified. For example, an innovation quotient, such as quotient 300 of FIG. 3, can be determined for an organization. The innovation quotient may identify which innovation maturity level 502 should be associated with the organization. Gaps 508 can then be identified when a value 506 for a characteristic 504 resides at a lower maturity level 502. In the illustrated example, the “Accepted” level may represent the desired maturity level 502, and gaps 508 exist because values 506 for four characteristics 504 reside at the “Initial” level 502.

Each gap 508 can be partially or completely corrected through a solution offering 510. Solution offering 510 represents one or more products, services, processes, or other mechanisms that could be used to close the gap 508 for a particular characteristic 504. For example, the solution offering 510 for the processes characteristic 504 could include idea repository software and policies, which may be used to disclose and share innovative ideas. The solution offering 510 for the processes characteristic 504 could also include change control forms and policies, which may be used to request and control changes to the products or services offered by the organization.

The solution offering 510 for the financial characteristic 504 could include templates for invisible balance sheets, which would allow funding for innovation to remain separate from ordinary business expenses. It could also include establishing an employee award program and a patent licensing program.

The solution offering 510 for the tools characteristic 504 could include idea tracking software for disclosing ideas and tracking the status of those ideas. It could also include idea ranking software for assigning priorities to ideas and a training package for educating employees and managers on the use of the tools.

The solution offering 510 for the personnel characteristic 504 could include a set of human resources policies, performance review policies, reward systems, and training to help improve the environment in which the employees operate. The solution offering 510 for the management characteristic 504 could include training courses and tools designed to educate the managers about the various innovation capabilities of the organization. The solution offering 510 for the employee perception characteristic 504 could include programs to educate and encourage the employees to use available tools. The solution offering 510 for the customer perception characteristic 504 could include programs to increase customer awareness of the value of innovation.

Although FIG. 5 illustrates one example of an innovation matrix 516 for quantitatively modeling innovation capabilities of an organization, various changes can be made to FIG. 5. For example, transition matrix 516 may include any number of maturity levels 502 and organizational characteristics 504. Also, the maturity levels 502, organizational characteristics 504, and values 506 illustrated in FIG. 5 are for illustration only.

FIG. 6 illustrates an example display 650 identifying current innovation capabilities of an organization. In the illustrated example, display 650 represents a dashboard display in a window that can be shown to a user. In this example, the display 650 includes one or more panels 652. The panels 652, the arrangement of the panels 652, and the contents of the panels 652 shown in FIG. 6 are for illustration only.

In this embodiment, panel 652a contains real-time information about specific innovation capabilities of an organization. For example, panel 652a includes information about revenue from patent licensing programs, the value of employee development abilities, the number of innovative ideas approved, and the value of white papers published. Panel 652a also includes a summary bar 654. Summary bar 654 identifies the current percentage of resources dedicated to innovation capabilities in a particular period, such as the current fiscal year. The innovation capabilities shown in panel 652a are for illustration only. Other or additional innovation capabilities could also be shown in panel 652a. In a particular embodiment, the user can specify which innovation capabilities are displayed in panel 652a. In this way, the display 650 can be customized for a particular user.

Panel 652b contains real-time information about various overall aspects of an organization. In this example, panel 652b contains information about the assets of the organization. A portion of the assets information may include an overall value or expense of the innovative capabilities of the organization. Other or additional overall aspects of the organization could also be shown in panel 652b. In a particular embodiment, the user can specify which aspects are displayed in panel 652b, allowing for additional customization of display 650.

Display 650 further provides for customized views of individual lines of the organization, such as for individual divisions 202 of organization 200. The different views may be available under different notebook tabs 656. Each division 202 of organization 200 could have a display similar to the arrangement and composition of display 650. Other or additional customized views could be supported in system 100 without departing from the scope of this disclosure.

System 100 may use any suitable information from any suitable source or sources to generate display 650. For example, dashboard generator 124 could access information contained in spreadsheets, accounting programs, idea tracking tools, human resources systems, and any other or additional repository of information.

Although FIG. 6 illustrates one example of a display 650 identifying current innovation capabilities of an organization, various changes may be made to FIG. 6. For example, other types of displays can be used in place of a dashboard display. Also, display 650 could include any number of panels 652, and each panel 652 may include any suitable information.

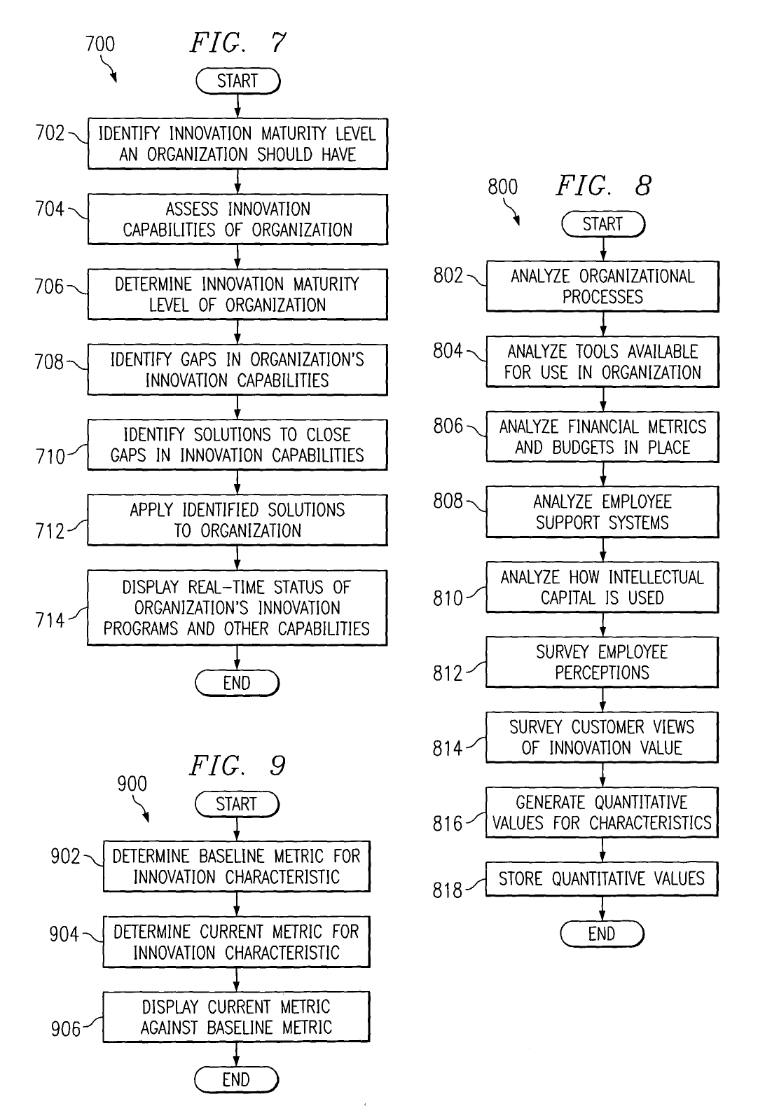

FIG. 7 illustrates an example method 700 for managing innovation capabilities of an organization. In the following description, some steps of method 700 may be described as being performed by a user of system 100, and other steps may be described as being performed by system 100. In another embodiment, each step could be performed by the same entity or by system 100.

The desired innovation maturity level of an organization is identified at step 702. This may include, for example, a user identifying the industry in which the organization operates. This may also include the user identifying the innovation maturity level 302 associated with the identified industry. This may further include the user using the graph illustrated in FIG. 3 to identify the innovation quotient 300 associated with the identified innovation maturity level 302.

The innovation capabilities of the organization are assessed at step 704. This may include, for example, the user performing an innovation assessment of the organization. In particular, this could include the user analyzing the various divisions 202 in an organization 200. The user could also analyze the organization in terms of the various characteristics 504 shown in FIG. 5. The user could further analyze these characteristics 504 for different categories of employees. Example categories may include organizational sets of employees, such as manufacturing, sales, and engineering employees. Example categories could also include communities of employees, such as financial, technical, and business employees.

The innovation maturity level of the organization is determined at step 706. This may include, for example, the user using the results of the innovation assessment to identify the current innovation maturity level of the organization. This may also include the user using the factors 400 illustrated in FIG. 4 to identify the current innovation maturity level 402 associated with the organization.

Gaps or problems in the organization's innovation capabilities are identified at step 708. This may include, for example, server 102 storing quantitative information generated during the assessment in a transition matrix. This may also include gap analyzer 120 or the user identifying aspects of the organization that fall below the desired innovation maturity level from step 702.

Solutions to any problems in the organization's innovation capabilities are identified at step 710. This may include, for example, server 102 or the user identifying solutions for each organizational characteristic that lacks a suitable amount of innovation capabilities. The identified solutions are made available to the organization at step 712. This may include, for example, installing products within the organization, providing services to the organization, establishing policies within the organization, and holding training sessions for people within or outside the organization.

The real-time status of the organization's innovation capabilities can be displayed to one or more users at step 714. This may include, for example, dashboard generator 124 retrieving organizational information 128 from databases 126 supported by the organization. This may also include dashboard generator 124 producing one or more displays for a user, such as the display 650 shown in FIG. 6. The display could further be customized to display specific information desired by the user.

Although FIG. 7 illustrates one example of a method 700 for managing innovation capabilities of an organization, various changes may be made to method 700. For example, the desired innovation maturity level could be identified after the actual innovation capabilities are assessed. Also, the real-time status of the organization's innovation capabilities could be displayed at any time. This may include before, during, and after the innovation assessment.

FIG. 8 illustrates an example method 800 for identifying an innovation maturity level of an organization. In the following description, steps in method 800 may be described as being performed by a user of system 100. In another embodiment, each step could be automated and performed by system 100.

The processes used within an organization are analyzed at step 802. This may include, for example, a user of system 100 identifying various processes 208 that support the creation, development, and implementation of innovative ideas in an organization 200. This could also include the user performing this analysis for an entire organization, by individual divisions 202, by communities of employees, or in any other suitable manner. This could further include the user determining whether the processes 208 are consistent throughout organization 200 or lack in one or more areas of organization 200.

The tools available within the organization are analyzed at step 804. This may include, for example, the user identifying various tools in an organization, such as idea tracking databases, knowledge repositories, or other components.

The financial metrics and budgets within the organization are analyzed at step 806. This may include, for example, the user determining whether funding for innovation is available in the organization. This may also include the user determining whether the budgets for innovation are separate from other operating budgets and whether funding is approved using suitable standards.

The employee support systems in the organization are analyzed at step 808. This may include, for example, the user identifying whether employees may collaborate and identify problems facing the organization and possible solutions. This may also include the user identifying whether an invention reward program exists and how effective it operates. This may further include the user determining whether training programs exist to ensure that employees know what tools, resources, and programs are available to support innovation.

The mechanisms for managing intellectual capital in the organization are analyzed at step 810. This may include, for example, the user determining whether employees and managers are trained to understand the importance of intellectual property rights. This could also include the user determining whether the organization has a policy on licensing intellectual property rights.

Employee perceptions on the organization's innovation capabilities are surveyed at step 812. This may include, for example, the user surveying random employees in various divisions 202, communities, or other groups within organization 200. Customer perceptions on the value of the organization's innovation capabilities are surveyed at step 814. This may include, for example, the user surveying customer attitudes about the organization.

Quantitative values for each characteristic are generated at step 816. This may include, for example, the user evaluating the presence or absence of each process, tool, financial setup, personnel or management attribute, and employee or customer perception. This may also include the user evaluating the strength of each. The overall score or value for each characteristic may represent the overall strength or weakness of each characteristic in supporting or inhibiting innovation in the organization.

The quantitative values are stored at step 818. This may include, for example, storing quantitative values 506 in transition matrix 516 of FIG. 5. This may also include inserting each quantitative value 506 into an entry 501 associated with a particular maturity level 502. The maturity level 502 associated with each characteristic can be selected in any suitable manner. For example, the magnitude of the quantitative value could be used to select a maturity level 502. Higher values would be placed in higher levels 502, and lower values would be placed in lower levels 502.

Although FIG. 8 illustrates one example of a method 800 for identifying an innovation maturity level of an organization, various changes may be made to method 800. For example, the various characteristics could be analyzed in any suitable order, and other or additional characteristics could be analyzed. Also, a quantitative value could be generated and stored as each characteristic is analyzed.

FIG. 9 illustrates an example method 900 for displaying current innovation capabilities of an organization. Method 900 may be described with respect to dashboard generator 124 in system 100 of FIG. 1. Other components of other systems could also use method 900 to display the current innovation capabilities of an organization.

Server 102 determines a baseline metric for an innovation characteristic at step 902. This may include, for example, dashboard generator 124 identifying the total amount of money to be awarded under an employee reward program for the current fiscal year. The information may be retrieved from spreadsheets or any other information repository.

Server 102 determines the current metric for that innovation characteristic at step 904. This may include, for example, dashboard generator 124 identifying the amount of money actually awarded to employees up to the current date of the current fiscal year. Server 102 displays the current metric mapped against the baseline metric at step 906. This may include, for example, dashboard generator 124 displaying a bar having a length representing the baseline metric. A line may be positioned in the bar such that the area on one side of the line is proportional to the current metric. Text could also be added around the bar. For example, text on one side of the bar could identify the current metric, and text on the other side of the bar could identify the difference between the baseline and current metrics. As a particular example, the baseline metric could indicate that the organization wishes to file one hundred patent applications this year, and the current metric could show that twenty have actually been filed. Dashboard generator 124 could generate a display having a bar, where the first end of the bar is labeled “20” and the second end of the bar is labeled “80”. The label “20” identifies the number of applications currently on file, and the label “80” identifies the number of applications remaining. A line could be placed one fifth of the way from the first end, showing that one-fifth of that metric has been completed so far.

Although FIG. 9 illustrates one example of a method 900 for displaying current innovation capabilities of an organization, various changes may be made to method 900. For example, the baseline metric can be identified after the current metric. Also, metrics for multiple characteristics can be displayed. Further, metrics can be displayed in other ways. As a particular example, the current metrics could be displayed without reference to the baseline metrics. In addition, server 102 could receive an indication from the user as to which information should be displayed and how it is to be displayed. Server 102 could then generate customized displays for the user.

While this disclosure has been described in terms of certain embodiments and generally associated methods, alterations and permutations of the embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

To aid the Patent Office and any readers of any patent issued on this application in interpreting the claims appended hereto, applicants wish to note that they do not intend any of the appended claims to invoke paragraph 6 of 35 U.S.C. § 112 as it exists on the date of filing hereof unless the words “means for” or “step for” are used in the particular claim.

What is claimed is:

1. A method, comprising:
storing one or more quantitative values associated with one or more innovation capabilities of an organization, each quantitative value also associated with one of a plurality of innovation levels;
determining an expected innovation level for the organization, the expected innovation level comprising one of the plurality of innovation levels;
identifying an innovation capability having a quantitative value associated with an innovation level that falls below the expected innovation level value; and
identifying one or more solutions associated with the identified innovation capability, wherein the one or more solutions are operable to increase the innovation level associated with the quantitative value.

2. The method of claim 1, wherein storing the one or more quantitative values comprises storing the quantitative values in a matrix, the matrix defined by a first axis and a second axis, the first axis associated with the innovation levels, the second axis associated with the innovation capabilities.

3. The method of claim 1, wherein determining the expected innovation level for the organization comprises:
determining an industry affiliation associated with the organization; and
identifying an expected innovation level associated with the industry affiliation.

4. The method of claim 1, further comprising generating the one or more quantitative values.

5. The method of claim 1, wherein the one or more innovation capabilities include at least one of a process used by the organization, a tool used by the organization, a financial arrangement used by the organization, an environment in which employees of the organization operate, an attitude of managers in the organization, a perception of the employees, and a perception of customers of the organization.

6. The method of claim 1, further comprising providing the one or more identified solutions to the organization.

7. The method of claim 1, further comprising generating a display for a user, the display comprising a real-time status of at least one of the innovation capabilities of the organization.

8. A system, comprising:
logic encoded on at least one computer readable medium; and
the logic operable when executed to:
identify at least one value representing a current status of at least one innovation capability of an organization;
generate a display using the at least one value; and
communicate the display for presentation to a user.

9. The system of claim 8, wherein:
the at least one value comprises at least one first value; and
the logic is further operable to identify at least one second value representing a desired final status of the at least one innovation capability of the organization.

10. The system of claim 9, wherein the logic is operable to generate the display by plotting the at least one first value against the at least one second value.

11. The system of claim 8, wherein the at least one value represents a revenue stream from a patent licensing program, a number of patent applications filed, a number of papers published, and a value of the innovation capabilities of the organization.

12. The system of claim 8, wherein the logic is operable to identify the at least one value by retrieving the at least one value from a spreadsheet.

13. The system of claim 8, wherein the logic is further operable to customize the display for the user.

14. The system of claim 8, wherein the logic is further operable to:
store one or more quantitative values associated with the at least one innovation capability of the organization, each quantitative value also associated with one of a plurality of innovation levels;
determine an expected innovation level for the organization, the expected innovation level comprising one of the plurality of innovation levels;
identify an innovation capability having a quantitative value associated with an innovation level that falls below the expected innovation level value; and
identify one or more solutions associated with the identified innovation capability, wherein the one or more solutions are operable to increase the innovation level associated with the quantitative value.

15. A system, comprising:
at least one memory operable to store at least one value representing a current status of at least one innovation capability of an organization; and
at least one processor operable to:
generate a display using the at least one value; and
communicate the display for presentation to a user.

16. The system of claim 15, wherein:
the at least one value comprises at least one first value;
the at least one processor is further operable to identify at least one second value representing a desired final status of the at least one innovation capability of the organization; and
the at least one processor is operable to generate the display by plotting the at least one first value against the at least one second value.

17. The system of claim 15, wherein the at least one processor is operable to identify the at least one value by retrieving the at least one value from a spreadsheet.

18. The system of claim 15, wherein the at least one processor is further operable to customize the display for the user.

19. The system of claim 15, wherein the at least one processor is further operable to store one or more quantitative values associated with the at least one innovation capability of the organization, each quantitative value also associated with one of a plurality of innovation levels.

20. The system of claim 19, wherein the at least one processor is further operable to:
determine an expected innovation level for the organization, the expected innovation level comprising one of the plurality of innovation levels;
identify an innovation capability having a quantitative value associated with an innovation level that falls below the expected innovation level value; and
identify one or more solutions associated with the identified innovation capability, wherein the one or more solutions are operable to increase the innovation level associated with the quantitative value.
